(19) United States
(12) Patent Application Publication
(10) Pub. No.: US 2022/0382490 A1
(43) Pub. Date: Dec. 1, 2022

(54) ENABLING PRINT JOB FUNCTIONALITY VIA PRINT ENABLEMENT DATA

(71) Applicant: Hewlett-Packard Development Company, L.P., Spring, TX (US)

(72) Inventors: Juan Guzman, Boise, ID (US); George Henry Kerby, Boise, ID (US); Paul L. Jeran, Boise, ID (US); Gabriel Scott McDaniel, Boise, ID (US)

(21) Appl. No.: 17/330,765

(22) Filed: May 26, 2021

(51) Int. Cl. G06F 3/12

(52) U.S. Cl. CPC G06F 3/1203; G06F 3/1229

(57) ABSTRACT

In some examples, a computing device can include a processing resource and a memory resource storing instructions to cause the processing resource to receive an authentication signal from an imaging device, authenticate the imaging device using the authentication signal, and transmit print enablement data to the imaging device to enable print job functionality for the imaging device in response to authenticating the authentication signal.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring a print material (e.g., ink, toner, etc.) to the physical medium.

### BRIEF DESCRIPTION OF THE DRAWINGS

FIG. 1 is an example of a system for enabling print job functionality via print enablement data consistent with the disclosure.

FIG. 2 is an example of a computing device for enabling print job functionality via print enablement data consistent with the disclosure.

FIG. 3 is a block diagram of an example system for enabling print job functionality via print enablement data consistent with the disclosure.

FIG. 4 is an example of a method for enabling print job functionality via print enablement data consistent with the disclosure.

### DETAILED DESCRIPTION

Imaging devices may include a supply of a print material. As used herein, the term “print material” refers to a substance which can be transported through and/or utilized by an imaging device. In some examples, print material can be, for instance, a material that when applied to a medium, can form representation(s) (e.g., text, images, models, etc.) on the medium during a print job. Print material may include ink, toner, polymers, metals, colorants, etc.

The print material can be deposited onto a physical medium. As used herein, the term “imaging device” refers to any hardware device with functionalities to physically produce representation(s) (e.g., text, images, models, etc.) on the medium. In some examples, a “medium” may include paper, photopolymers, plastics, composite, metal, wood, fabric, or the like. An imaging device can further include other functionalities such as scanning, faxing, and/or other imaging device functionalities, and can perform print jobs when in receipt of a print job request from a computing device or other network (e.g., Internet) connected device.

A device, such as a computing device, can generate a print job request and transmit the print job request to the imaging device. The imaging device can perform the print job according to the received print job request.

The imaging device can perform the print job by depositing print material onto a print medium from a print material supply or other print medium reloading device. As used herein, the term “print material supply” refers to a vessel including print material. For example, the print material supply can include print material that can be deposited onto a print medium to form text and/or images on the print medium during a print job. A print material supply can be, for instance, a process/toner cartridge (e.g., P-Cart/T-Cart), discrete supplies (e.g., toner, developer drum (including a toner cartridge), etc.), among other examples.

In previous approaches, the print material supply could include a memory storing print enablement data. As used herein, the term “print enablement data” refers to encoded information utilized by an imaging device to perform print job operations. Once the print material supply is installed in the imaging device, the imaging device can utilize the print enablement data to perform print job operations, such as performing print jobs, as is further described herein.

Utilizing the print enablement data stored on a memory of the print material supply can ensure a customer receives and uses an authentic print material supply. However, in an example in which an update to the print enablement data is made, the update may take time to be distributed into the marketplace and to consumers. For example, at a time when the update to the print enablement data is completed, there may be already a plurality of print material supplies having the outdated print enablement data that are manufactured and waiting to be sold. Accordingly, it may take time for print material supplies including the updated print enablement data to be distributed

Enabling print job functionality via print enablement data according to the disclosure can allow for distribution of print enablement data without waiting for print material supplies to be distributed into the marketplace. Print enablement data can be transmitted from a computing device to the imaging device, bypassing the use of the memory on the print material supply. Print enablement data can be updated and transmitted to an imaging device more quickly than providing the print enablement data on a memory included on a print material supply and waiting for distribution into the marketplace. As such, enabling print job functionality via print enablement data according to the disclosure can provide an end user a better customer experience by providing faster updates to better optimize print jobs performed by the imaging device and additional security against counterfeit print material supplies as compared with previous approaches.

FIG. 1 is an example of a system 100 for enabling print job functionality via print enablement data consistent with the disclosure. The system 100 can include computing device 102 and imaging devices 106-1, 106-2, 106-N.

As illustrated in FIG. 1, the system 100 can include a plurality of imaging devices 106-1, 106-2, 106-N (referred to collectively herein as imaging devices 106). Each of the imaging devices 106-1, 106-2, 106-N can include a print material supply 108-1, 108-2, 108-N, respectively. Additionally, each of the imaging devices 106 can be connected to the computing device 102. The computing device 102 can, as a result, transmit print enablement data 104 to imaging devices 106-1, 106-2, 106-N, respectively, as is further described herein.

The imaging devices 106 can be connected to the computing device 102 via a wired and/or wireless network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), Near Field Communication (NFC), infrared (IR) communication, Public Switched Telephone Network (PSTN), radio waves, and/or the Internet, among other types of network relationships.

In order to receive print enablement data 104, an imaging device of the imaging devices 106 can transmit an authentication signal. Although examples described herein refer to imaging device 106-1, the examples can be applied to the other imaging devices 106-2, 106-N.

The imaging device 106-1 can transmit an authentication signal to the computing device 102. As used herein, the term “authentication signal” refers to an electrical quantity or effect to convey information. For example, the authentication signal transmitted by the imaging device 106-1 to the computing device 102 can include a username and password. The authentication signal can function to verify that a user of the imaging device 106-1 is a registered user of a print job service, for example. Print enablement data can be provided to the imaging device 106-1 associated with the user according to the terms of the print job service to allow for optimized print jobs and security utilizing the imaging device 106-1.

As used herein, the term “computing device” refers to an electronic system having a processing resource, memory resource, and/or an application-specific integrated circuit (ASIC) that can process information. Examples of computing devices can include, for instance, a laptop computer, a notebook computer, a desktop computer, an All-In-One (AIO) computing device, networking equipment (e.g., router, switch, etc.), and/or a mobile device, among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices. The computing device 102 can represent, in some examples, a cloud computing environment.

The computing device 102 can receive the authentication signal from the imaging device 106-1. Using the authentication signal, the computing device 102 can authenticate the imaging device 106-1. For example, the computing device 102 can verify whether the provided username and password associated with the imaging device 106-1 included in the authentication signal are correct.

Although the authentication signal is described above as being a username and password, examples of the disclosure are not so limited. For example, the authentication signal can include biometric information provided by a user of the imaging device 106-1 (e.g., fingerprint scan, retinal scan, voice sample, etc.), token authentication (e.g., a dongle, card, or other device connected to the imaging device 106-1), and/or combinations thereof (e.g., multi-factor authentication).

In an example in which the authentication signal is not authenticated, the computing device 102 can prevent transmission of the print enablement data 104 to the imaging device 106-1. For example, in response to the username and password not being verified, the computing device 102 can refrain from transmitting the print enablement data 104 to the imaging device 106-1, which can in some examples restrict or prevent the imaging device 106-1 from performing print jobs.

In response to the authentication signal being authenticated by the computing device 102, the computing device 102 can select print enablement data 104 from a plurality of print enablement data files. The computing device 102 can include a database of print enablement data files. For example, the database of print enablement data files can include multiple print enablement data files each corresponding to a different imaging device 106. For instance, a first print enablement data file can correspond to the imaging device 106-1, a second print enablement data file can correspond to the imaging device 106-2, a N^{th} print enablement data file can correspond to the imaging device 106-N, etc.

Accordingly, the computing device can select the print enablement data 104 included in a print enablement data file corresponding to the imaging device 106-1. Selection of the print enablement data 104 included in the print enablement data file corresponding to the imaging device 106-1 can be accomplished utilizing the authentication signal. For example, the authentication signal can further include identification information corresponding to the imaging device 106-1. Such identification information can include, for instance, a universally unique identifier (UUID), the username and password, imaging device identification information (e.g., media access control (MAC) address of the imaging device 106, serial number of the imaging device 106, among other examples of imaging device identification information.

In some examples, the computing device 102 can generate print enablement data 104 for a print enablement data file for the imaging device 106-1. For example, the imaging device 106-1 may be a new imaging device and utilizing the authentication signal, the computing device 102 can generate a print enablement data file corresponding to the imaging device 106-1.

As described above, the print enablement data 104 can include encoded information utilized by an imaging device 106 to perform print job operations. Such encoded information can be received by an imaging device 106, processed by the imaging device 106, and utilized by the imaging device 106 to perform print jobs, as is further described herein.

In some examples, the print enablement data 104 can include a print quality table. As used herein, the term “print quality table” refers to basic image processing and algorithmic enhancement table data to enable print jobs.

In some examples, the print enablement data 104 can include a color map. As used herein, the term “color map” refers to an array of colors used to map pixel data to color values. For example, the color map can be utilized by an imaging device 106 to direct how print material (e.g., ink, toner, etc.) is laid down on a print medium during a print job.

In some examples, the print enablement data 104 can include a print mode. As used herein, the term “print mode” refers to a designated condition or status for performing a print job. For example, the print mode of an imaging device 106 can include a print resolution, color, black and white, portrait, landscape, etc., as well as in some examples data supporting capabilities for receiving and enabling future print modes, where such print enablement data may be utilized by firmware of the imaging device 106-1. The print modes included in the print enablement data 104 can include print modes supported by the imaging device 106-1. For example, the print enablement data 104 included in a print enablement data file corresponding to the imaging device 106-1 can include print modes supported by the imaging device 106-1 but not print modes that are not supported by the imaging device 106-1.

In some examples, the print enablement data 104 can include print material supply identification information. As used herein, the term “print material supply identification information” refers to identifying information describing a print material supply. For example, the print material supply identification information can include information for use by a firmware of the imaging device 106-1 to identify a print material supply 108-1 as authentic. Such information can be utilized to prevent unauthorized and/or counterfeit print material supplies from being utilized by the imaging device 106-1, as is further described herein.

In some examples, the print enablement data 104 can include parameters for messaging. For example, the print enablement data 104 can include thresholds, such as print material thresholds, print media thresholds, etc. Such thresholds can define when the imaging device 106-1 transmits messages. For instance, the thresholds can define when the imaging device 106-1 transmits a low toner message, a very low toner message, etc.

In some examples, the print enablement data 104 can include code to drive an imaging engine of an imaging device 106. Code to drive an imaging engine can include instructions executable by a processing resource (e.g., an imaging engine) of an imaging device 106 to cause the imaging device 106 to perform print jobs.

Accordingly, as described above, the print enablement data 104 can be information utilized by an imaging device 106 to perform print job operations. By transmitting such print enablement data 104 to an imaging device 106 when the imaging device 106 has been authenticated, the computing device 102 can prevent or limit operation of the imaging device 106 if the imaging device 106 is unauthorized, utilizes an unauthorized/counterfeit print material supply, etc. Such an approach can lead to an increase in security for imaging device operations as well as provide an improved customer printing experience as compared with previous approaches as such print enablement data 104 may be updated to enhance and/or optimize print jobs by such imaging devices 106.

Although the print enablement data 104 is described above as including a print quality table, a color map, a print mode, print material supply identification information, and/or code to drive an imaging engine, examples of the disclosure are not so limited. For example, the print enablement data 104 can include any combination thereof and/or any other type of data utilized by an imaging device to perform a print job.

The computing device 102 can transmit the print enablement data 104 to the imaging device 106-1 to enable print job functionality for the imaging device 106-1. For example, the print enablement data 104 transmitted to the imaging device 106-1 can include color maps to direct how the imaging device 106-1 is laid down on a print medium, print modes supported by the imaging device 106-1, print material supply identification information to verify the print material supply 108-1 as authentic, messaging parameters to generate notifications for a user of the imaging device 106-1, and/or code to drive an imaging engine of the imaging device 106-1 to enable the imaging device 106-1 to perform print jobs.

In response to receiving a print job request, the imaging device 106-1 can perform a print job utilizing the print enablement data 104. For example, the print job request may include a request to print an image of a building on a print medium, where the imaging device 106-1 can utilize a particular color map to print the building in a color format and utilizing the code to drive the imaging engine of the imaging device 106-1 to enable the imaging device 106-1 to print the imagine of the building on the print medium. In some examples, firmware of the imaging device 106-1 can utilize the print enablement data 104 to cause the imaging device 106-1 to perform the print job.

As mentioned above, the imaging device 106-1 can authenticate the print material supply 108-1 utilizing the print enablement data 104. For example, the print enablement data 104 can include print material supply identification information. The print material supply identification information can include a unique identifier, cryptographic information, etc. The unique identifier and/or cryptographic information can be utilized to verify the print material supply 108-1 is authentic by comparing the unique identifier and/or cryptographic information included as print material supply identification information in the print enablement data 104 to an identifier and/or cryptographic information included in the print material supply 108-1. By comparing such information, the imaging device 106-1 can verify the print material supply 108-1 is authentic. In response to the imaging device 106-1 authenticating the print material supply 108-1 using the print enablement data 104, the imaging device 106-1 can perform a print job.

In some examples, in response to the imaging device 106-1 not authenticating the print material supply 108-1, the imaging device 106-1 can perform the print job utilizing default print enablement data. The default print enablement data can include print enablement data to allow the imaging device 106-1 to perform print jobs but may restrict or prevent the use of capabilities the imaging device 106-1 may possess. For instance, while the imaging device 106-1 may include the capability to perform color print jobs, the default print enablement data may restrict the imaging device 106-1 from performing color print jobs and allow merely black and white print jobs to occur.

In some examples, in response to the imaging device 106-1 not authenticating the print material supply 108-1, the imaging device 106-1 can prevent the print job from occurring. That is, the imaging device 106-1 may not perform the print job if the print material supply 108-1 is not authenticated (e.g., using the print enablement data 104).

As described above, in some instances the print enablement data 104 may be updated. For example, a color map may be updated to provide richer application of color to a print medium during a print job. Accordingly, the color maps in the print enablement data 104 may be updated as well. As another example, a new print mode may be generated (e.g., coded) to enable new printing capabilities for imaging devices 106. The computing device 102 can further transmit the updated print enablement data 104 to the imaging devices 106. The imaging devices 106 can, as such, utilize the updated print enablement data 104 (e.g., utilize the updated color map) during subsequent print jobs.

Enabling print job functionality via print enablement data according to the disclosure can allow for print enablement data to be transmitted to an imaging device without delay as compared with previous approaches. Faster print enablement data updates can provide a better user experience and additional security against counterfeit print material supplies as compared with previous approaches.

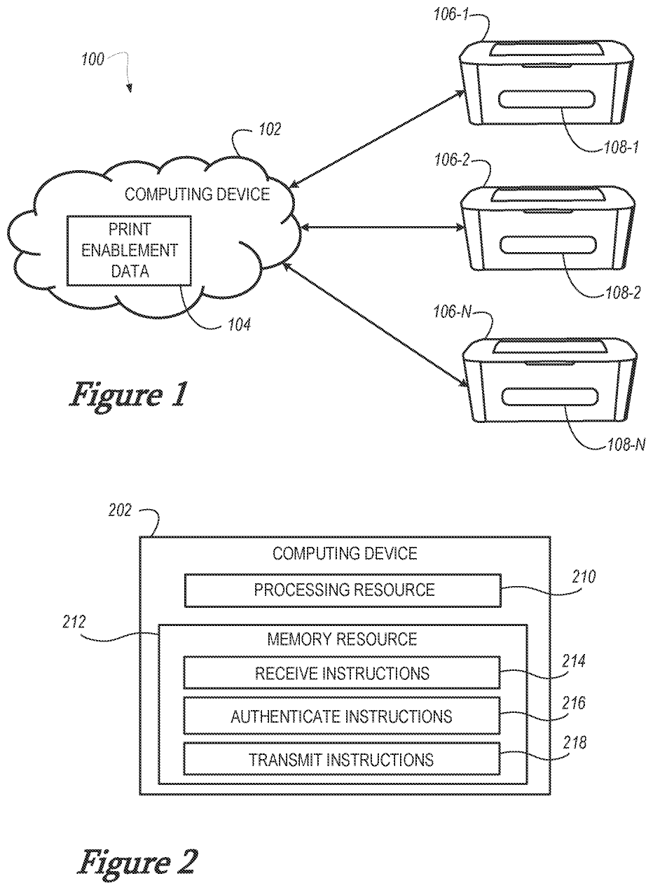

FIG. 2 is an example of a computing device 202 for enabling print job functionality via print enablement data consistent with the disclosure. As described herein, the computing device 202 may perform functions related to enabling print job functionality via print enablement data. Although not illustrated in FIG. 2, the computing device 202 may include a processor and a machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple machine-readable storage mediums and across multiple processors. Put another way, the instructions executed by the computing device 202 may be stored across multiple machine-readable storage mediums and executed across multiple processors, such as in a distributed or virtual computing environment.

Processing resource 210 may be a central processing unit (CPU), a semiconductor-based microprocessor, and/or other hardware devices suitable for retrieval and execution of machine-readable instructions 214, 216, 218 stored in a memory resource 212. Processing resource 210 may fetch, decode, and execute instructions 214, 216, 218. As an alternative or in addition to retrieving and executing instructions 214, 216, 218, processing resource 210 may include a plurality of electronic circuits that include electronic components for performing the functionality of instructions 214, 216, 218.

Memory resource 212 may be any electronic, magnetic, optical, or other physical storage device that stores executable instructions 214, 216, 218, and/or data. Thus, memory resource 212 may be, for example, Random Access Memory (RAM), an Electrically-Erasable Programmable Read-Only Memory (EEPROM), a storage drive, an optical disc, and the like. Memory resource 212 may be disposed within computing device 202, as shown in FIG. 2. Additionally, memory resource 212 may be a portable, external or remote storage medium, for example, that causes computing device 202 to download the instructions 214, 216, 218 from the portable/external/remote storage medium.

The computing device 202 may include instructions 214 stored in the memory resource 212 and executable by the processing resource 210 to receive an authentication signal from an imaging device. The authentication signal can include, in some examples, a username and a password of a user associated with the imaging device.

The computing device 202 may include instructions 216 stored in the memory resource 212 and executable by the processing resource 210 to authenticate the imaging device using the authentication signal. For example, the computing device 202 can verify whether the username and password of the user associated with the imaging device is correct.

The computing device 202 may include instructions 218 stored in the memory resource 212 and executable by the processing resource 210 to transmit print enablement data to the imaging device to enable print job functionality for the imaging device in response to authenticating the authentication signal. The imaging device can utilize the print enablement data to perform print jobs.

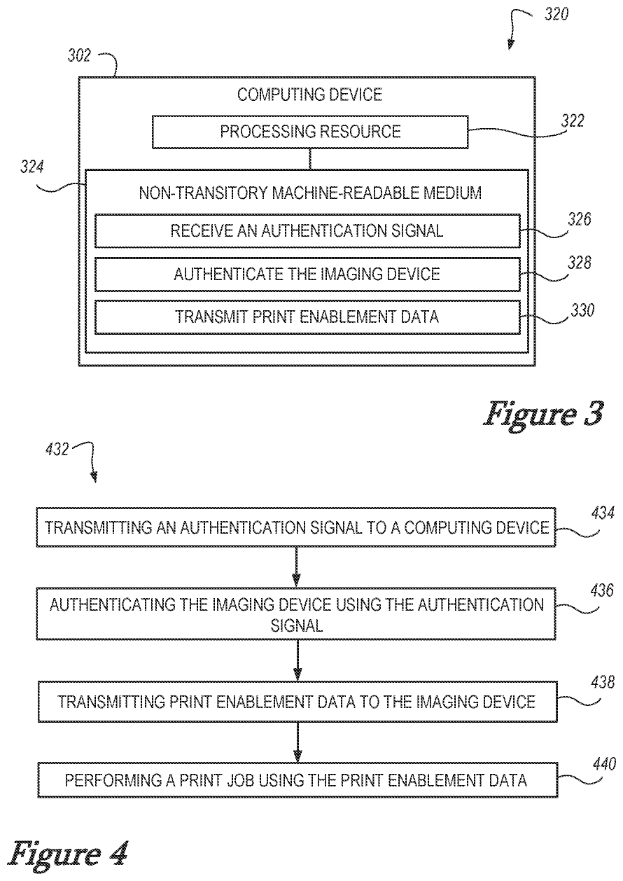

FIG. 3 is a block diagram of an example system 320 for enabling print job functionality via print enablement data consistent with the disclosure. In the example of FIG. 3, system 320 includes a computing device 302 including a processing resource 322 and a non-transitory machine-readable storage medium 324. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 322 may be a central processing unit (CPU), microprocessor, and/or other hardware device suitable for retrieval and execution of instructions stored in the non-transitory machine-readable storage medium 324. In the particular example shown in FIG. 3, processing resource 322 may receive, determine, and send instructions 326, 328, 330. As an alternative or in addition to retrieving and executing instructions, processing resource 322 may include an electronic circuit comprising a number of electronic components for performing the operations of the instructions in the non-transitory machine-readable storage medium 324. With respect to the executable instruction representations or boxes described and shown herein, it should be understood that part or all of the executable instructions and/or electronic circuits included within one box may be included in a different box shown in the figures or in a different box not shown.

The non-transitory machine-readable storage medium 324 may be any electronic, magnetic, optical, or other physical storage device that stores executable instructions. Thus, the non-transitory machine-readable storage medium 324 may be, for example, Random Access Memory (RAM), an Electrically-Erasable Programmable Read-Only Memory (EEPROM), a storage drive, an optical disc, and the like. The executable instructions may be “installed” on the system 320 illustrated in FIG. 3. The non-transitory machine-readable storage medium 324 may be a portable, external or remote storage medium, for example, that allows the system 320 to download the instructions from the portable/external/remote storage medium. In this situation, the executable instructions may be part of an “installation package”.

Receive an authentication signal instructions 326, when executed by a processor such as processing resource 322, may cause system 320 to determine receive an authentication signal from an imaging device. The authentication signal can include, in some examples, a username and a password of a user associated with the imaging device.

Authenticate the imaging device instructions 328, when executed by a processor such as processing resource 322, may cause system 320 to authenticate the imaging device using the authentication signal. For example, the computing device 302 can verify whether the username and password of the user associated with the imaging device is correct.

Transmit print enablement data instructions 330, when executed by a processor such as processing resource 322, may cause system 320 to transmit print enablement data to the imaging device to enable print job functionality for the imaging device. The imaging device can perform print jobs utilizing the print enablement data in response to receiving a print job request.

FIG. 4 is an example of a method 432 for enabling print job functionality via print enablement data consistent with the disclosure. The method 432 can be performed by a computing device (e.g., computing device 102, 202, 302, previously described in connection with FIGS. 1, 2, and 3, respectively) and an imaging device (e.g., imaging devices 106-1, 106-2, 106-N, previously described in connection with FIG. 1).

At 434, the method 432 includes transmitting, by an imaging device, an authentication signal from the imaging device to a computing device. The authentication signal can include, in some examples, a username and a password of a user associated with the imaging device, among other types of authentication information.

At 436, the method 432 includes authenticating, by the computing device, the imaging device using the authentication signal. For example, the computing device can verify whether the username and password of the user associated with the imaging device is correct.

At 438, the method 432 includes transmitting, by the computing device, print enablement data to the imaging device to enable print job functionality for the imaging device. The print job functionality can be enabled by the imaging device in response to receiving the print enablement data.

At 440, the method 432 includes performing, by the imaging device, a print job utilizing the print enablement data. The imaging device can perform the print job in response to receiving a print job request.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 100 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

1. A computing device, comprising:
a processing resource; and
a memory resource storing non-transitory machine-readable instructions to cause the processing resource to:
receive an authentication signal from an imaging device;
authenticate the imaging device using the authentication signal; and
transmit print enablement data to the imaging device to enable print job functionality for the imaging device in response to authenticating the authentication signal, wherein the print enablement data includes encoded print material supply identification information utilized by the imaging device to identify a print material supply installed in the imaging device as authentic and to perform a print job in response to receiving a print job request.

2. The computing device of claim 1, wherein the processing resource is to select the print enablement data from a plurality of print enablement data files.

3. The computing device of claim 2, wherein:
the print enablement data corresponds to the imaging device; and
the plurality of print enablement data files each correspond to a different imaging device.

4. The computing device of claim 1, wherein the processing resource is to update the print enablement data.

5. The computing device of claim 4, wherein the processing resource is to transmit the updated print enablement data to the imaging device.

6. A system, comprising:
an imaging device, wherein the imaging device is to transmit an authentication signal to a computing device; and
the computing device to:
receive the authentication signal from the imaging device;
authenticate the imaging device using the authentication signal; and
transmit print enablement data to the imaging device to enable print job functionality for the imaging device in response to authenticating the authentication signal, wherein the print enablement data includes encoded print material supply information utilized by the imaging device to identify a print material supply installed in the imaging device as authentic and to perform a print job in response to receiving a print job request;
wherein the imaging device is to perform the print job utilizing the print enablement data in response to receiving the print job request.

7. The system of claim 6, wherein firmware of the imaging device is to utilize the print enablement data to cause the imaging device to perform the print job.

8. The system of claim 6, wherein the print enablement data further includes a print quality table.

9. The system of claim 6, wherein the print enablement data further includes a color map.

10. The system of claim 6, wherein the print enablement data further includes a print mode.

11. (canceled)

12. A method, comprising:
transmitting, by an imaging device, an authentication signal from the imaging device to a computing device;
authenticating, by the computing device, the imaging device using the authentication signal;
transmitting, by the computing device, print enablement data to the imaging device to enable print job functionality for the imaging device in response to authenticating the authentication signal, wherein the print enablement data includes encoded print material supply information utilized by the imaging device to identify a print material supply installed in the imaging device as authentic and to perform a print job in response to receiving a print job request; and
performing, by the imaging device, the print job utilizing the print enablement data in response to receiving the print job request.

13. The method of claim 12, wherein the method includes authenticating, by the imaging device, the print material supply utilizing the print enablement data.

14. The method of claim 13, wherein the method includes at least one of:
performing, by the imaging device, the print job utilizing default print enablement data in response to the print material supply not being authenticated; and
preventing, by the imaging device, the print job in response to the print material supply not being authenticated.

15. The method of claim 12, wherein the method includes preventing, by the computing device, transmitting the print enablement data to the imaging device in response to the authentication signal not being authenticated.
